(19) United States
(12) Patent Application Publication
(10) Pub. No.: US 2012/0203426 A1
(43) Pub. Date: Aug. 9, 2012

(54) MOTOR VEHICLE WITH ADAPTIVE CHASSIS

(75) Inventors: Veit HELD, Bensheim (DE); Dario BAGNOLI, Ginsheim-Gustavsburg (DE); Igor ZIVKOVIC, Darmstadt (DE); Prashant Jagdish NARULA, Mainz (DE); Andreas HEITMANN, Wiesbaden (DE); Andreas KULMS, Huenfelden (DE); Ralf MAJEWSKI, Trebur (DE)

(73) Assignee: GM GLOBAL TECHNOLOGY OPERATIONS LLC, Detroit, MI (US)

(21) Appl. No.: 13/368,973

(22) Filed: Feb. 8, 2012

(30) Foreign Application Priority Data
Feb. 9, 2011 (DE) 10 2011 010 714.2

(51) Int. Cl. G06F 7/00

(52) U.S. Cl. 701/36

(57) ABSTRACT

A motor vehicle includes, but is not limited to an adaptive chassis that switches between at least a first and a second operating mode. At least one operating parameter of the chassis has different values in the first and in the second operating mode at the same speed and at the same acceleration of the motor vehicle. The motor vehicle also includes, but is not limited to a control unit that is arranged to evaluate the driving style of the driver and to activate the first or the second operating mode according to the result of the evaluation, and a signal generator that is able to be noticed by the driver of the vehicle, to deliver a signal indicating the respectively active operating mode.

### CROSS-REFERENCE TO RELATED APPLICATION

This application claims priority to German Patent Application No. 10 2011 010 714.2, filed Feb. 9, 2011, which is incorporated herein by reference in its entirety.

### TECHNICAL FIELD

The technical field relates to a motor vehicle with a chassis capable of switching between at least a first and a second operating mode for adaptation to different usage conditions.

### BACKGROUND

From EP 1 355 209 A1 a motor vehicle is known, in which the driver can set different usage conditions of the vehicle on a selector switch and can thereby influence various operating parameters of the motor vehicle. Thus, via the selector switch, the driver can set the type of ground travelled, such as for instance normal road, grass, gravel, snow, mud, sand etc., or he can select between normal driving behavior, sporty driving behavior and driving behavior suitable for operation as a towing vehicle. Operating parameters that are influenced by such a choice of the operating mode include, for example, the height of a wheel suspension, the efficiency of a servo-steering mechanism, etc. As the driver must carry out the choice of the operating mode, this driver is kept informed at all times of the operating mode that has been set, provided the driver is fully attentive. However, on changing the usage conditions of the vehicle, e.g., on changing the ground, which is travelled over, the driver, may forgets to alter the selected operating mode, so that the vehicle is not optimally adapted to its respective usage situation. This can result in losses of fuel efficiency, if due to an operating mode that has not been adapted, the vehicle does not show the behavior which the driver expects of it, e.g., when driving quickly around a bend.

Vehicles have also been proposed, in which an adaptation of operating parameters of the chassis, in particular, the rigidity of a shock absorber, takes place continuously as a function of the respective movement status of the vehicle. For example, a shock absorber set harder at high speed and on high sideways acceleration than at low speed or on low sideways acceleration, a high degree of travelling comfort on travelling straight or respectively slowly can be combined with a stable cornering ability at higher speeds. Such a combination is, however, not satisfactory for every driver; a driver who is oriented toward comfort can sense the hard suspension on driving around bends as being intrusive, where, on the other hand, a sporty driver appreciates the more intensive feedback from the roadway, which is provided by firm shock absorbers, even when driving more slowly.

In order to counteract this problem, a motor vehicle is presented in WO 2007/107363 with a control unit evaluating the driving style of the driver in this vehicle, it is able to set the chassis to be comfortable for a driver who reveals a comfort orientation. For example, by on average moderate, less erratic travel speed and low accelerations, independently of the present movement status of the vehicle, and to set it so as to be sporty, on the other hand, for a sporty driver.

However, the problem arises that the style of a driver can differ according to the present mood or haste, and that consequently the control unit can carry out a switching of the operating mode at times that are not able to be predicted precisely, in order to adapt itself to this driving style. If the changes to the driving behavior resulting from a change of the operating mode are not so great that the driver senses them immediately and reliably, then the driver also does not know with certainty about the respectively set operating mode and consequently cannot consider it when driving. If, on the other hand, the changes are great and are distinctly noticeable, the risk exists that the driver is surprised and confused by a suddenly changed behavior of the vehicle.

It is at least one object to provide a motor vehicle having a chassis able to switch between different operating modes. On the one hand, ensuring that a non-adapted operating mode is not permanently, but on the other hand, in which it can be prevented that the driver is confused by a change of the travelling behavior resulting from an adaptation of the operating mode. In addition, other objects, desirable features, and characteristics will become apparent from the subsequent summary and detailed description, and the appended claims, taken in conjunction with the accompanying drawings and this background.

### SUMMARY

A motor vehicle is provided that has an adaptive chassis able to switch between at least a first and a second operating mode, in which an operating parameter of the chassis in the first and in the second operating mode has different values at the same speed and the same acceleration of the motor vehicle. In addition, a control unit evaluates the driving style of the driver, and activates the first or the second operating mode depending on the result of the evaluation, equipped with a signal generator, able to be noticed by the driver of the vehicle, for delivering a signal indicating the respectively active operating mode. The evaluation of the driving style, in particular as sporty or comfort-oriented, based expediently on the monitoring of one or more parameters. The parameters, for example, selected under longitudinal and transversal acceleration of the vehicle, the speed of change of its yaw rate and the angular speed of the steering wheel, i.e., the speed at which the driver carries out steering maneuvers.

The operating modes differ from each other by the values of one or more operating parameters. The operating state of an all-wheel drive of the chassis comes into consideration, in particular, as such an operating parameter. For example, because with a sporty manner of driving it is expedient to activate an all-wheel drive, at least when driving quickly around a bend, in order to distribute the drive force to front and rear axles of the vehicle and thereby to reduce the tendency of the vehicle to over- or under-steering.

The hardness of a shock absorber of the chassis or the strength of the assisted steering by a servo-steering mechanism come into consideration as further operating parameters. The strength of the assisted steering will generally be less with a sporty driving style than with a comfort-oriented driving style, in order to give the sporty driver a stronger feedback via the steering thrust with respect to centrifugal forces acting on the vehicle.

The shifting characteristic of an automatic transmission of the motor vehicle is also different according to the operating mode; in particular, for a sporty driver the speeds or rotation rates at which a shift respectively takes place lie higher than for a comfort-oriented driver. The correlation between accelerator pedal position and engine output is steeper with a sporty driving style than with a comfort-oriented driving style, so that in the former case, already a relatively small deflection of the accelerator pedal is sufficient in order to bring about a distinct acceleration of the vehicle.

Expediently, via a suitable user interface the driver is offered the choice as to whether an automatic adaptation of the operating mode by means of the driving style, or whether the driver wishes to specify. The signal of the signal generator can be an acoustic signal; thus, the driver can also be reliably and immediately aware of a change to the operating mode even when his eyes are resting on the surrounding traffic. Irrespective of the nature of the signal, it is expedient if the signal generator generates a signal with a continuous information content, which changes on a change of the operating mode.

So that an acoustic signal of this type does not have an irritating effect, it should be expediently related to the background driving noises, which are present in any case. Thus, for example, it is conceivable that the signal generator modifies the type of transmission of the engine noise into the passenger compartment according to the operating mode, or that in one of the operating modes a loudspeaker emits a modified engine noise, so that on the spectrum of the resulting background noise, the respectively active operating mode is able to be heard therefrom at all times. A light signal, the color of which indicates the respectively active operating mode, is ideally suited as a continuous signal.

When the driver has the opportunity to determine the operating mode, then the color of the light signal should indicate the respectively active operating mode at least when the latter is determined through the control unit, and in addition, by at least one further color, it should be identifiable whether the operating mode is selected by the driver at the user interface. Thus, the driver can also detect immediately from the color of the signal whether or not he can influence the operating mode by his driving style.

According to another embodiment, this light signal illuminates a display instrument that serves per se to indicate an operating parameter of the vehicle that is different from the operating mode. Thus, the active operating mode is, for example, able to be read by means of the color with which the usual instruments of a dashboard, such as for instance tachometer, revolution counter, etc., are illuminated.

### BRIEF DESCRIPTION OF THE DRAWINGS

The present invention will hereinafter be described in conjunction with the following drawing figures, wherein like numerals denote like elements, and:

FIG. 1 is a diagrammatic view of a dashboard of a motor vehicle according to an embodiment; and

FIG. 2 is a highly schematized partial section through a motor vehicle according to an embodiment.

### DETAILED DESCRIPTION

The following detailed description is merely exemplary in nature and does not limit application and uses. Furthermore, there is no intention to be bound by any theory presented in the preceding background or summary or the following detailed description.

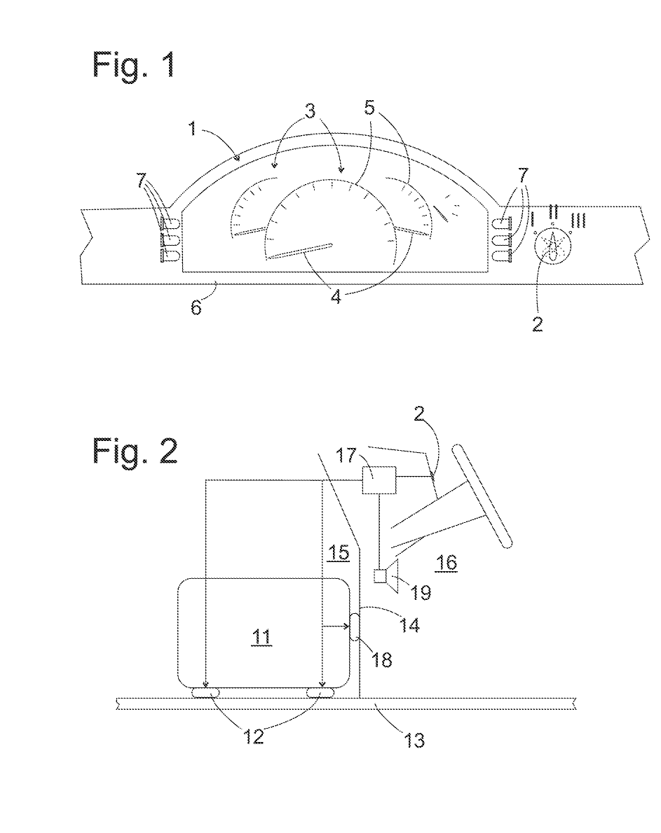

On the dashboard of a motor vehicle shown in FIG. 1, adjacent to an instrument panel 1 a selector lever 2 is arranged, on which three positions, marked by I, II or respectively III, can be set by the driver. When the driver selects position I, the first out of two operating modes of the motor vehicle, to be explained in further detail below, is specifically selected. The second mode is specifically selected when the selector lever 2 is situated in position III. In the position II lying therebetween, an automatic selection of the operating mode is possible by an on-board computer 17 (see FIG. 2), which is not illustrated in the figure. The on-board computer 17 monitors the driving behavior of the driver, e.g., the speed of steering actions, the intensity of actuation of the accelerator or respectively brake pedal or suchlike, in order to classify the driving style of the driver into one of at least two categories, such as for instance “sporty” or “comfort-oriented.” Methods for carrying out such a classification are described in the already mentioned WO 2007/107363 A1 and in EP 2 106 936 A1, so that the description thereof is superfluous at this point. It is clear that a classification of the driving style is also possible into three or more categories. In such a case, the number of positions of the selector lever 2 and if applicable the degrees of freedom of its actuation is increased in a suitable manner.

The instrument panel 1 can also have, in a manner known, one or more needle instruments 3, in which the position of a needle 4 or of another movable element relative to a scale 5 indicates an operating value of the vehicle, such as for instance speed, engine rotation speed, cooling water temperature, tank filling level, etc. Alternatively, the instrument panel 1 can be embodied as a screen, e.g., by LCD technology, on which freely programmable graphic contents are able to be represented, such as for instance images of needle instruments 3 and their components 4, 5 or else alphanumeric contents.

Behind an opaque frame 6 surrounding the instrument panel 1, several groups of illuminants 7 are arranged in a number enabling a uniform illumination of the entire instrument panel 1. In the figure, two such groups of illuminants 7 are illustrated; in practice, their number will generally be greater. Preferably, the illuminants 7 are LEDs of various colors. According to a first variant, one of these LEDs 7 of each group, preferably a white light LED, is always switched on when the selector lever 2 is in position I or III, whereas in position II this first LED is switched off and instead a second, e.g., red, LED 7 is switched on, when the on-board computer 17 has classified the driver as being comfort-oriented and has activated the first operating mode, whereas the third, example. blue, LED 7 in the second mode, is switched on classification of the driver as sporty. The driver can therefore detect the respectively active operating mode at any time by means of the color of the instrument panel 1, without having to read a specific instrument 3. In positions I, III of the selector lever 2, the second and third LED can be respectively switched off, so that the instrument panel 1 in this case appears to be purely white. However, it is also conceivable to keep the second LED switched on in position I, on the other hand the third LED in position III, so that also in this case the operating mode selected by the driver is able to be read from a pale red or respectively a pale blue shade of the instrument panel 1. It is clear that other combinations of colors of the LEDs 7 are available for use.

It is also conceivable in each group and in each case to use one LED 7 in the three primary colors red, green, blue, in order to realize a white illumination through simultaneous operation of all three LEDs 7, and to realize an illumination in two discretionary colors, associated with the operating modes, by controlling the light intensity of the three LEDs 7. A further possibility is to use, in each group, only two differently colored LEDs. One that indicates the choice of the first operating mode by the on-board computer, and the other that indicates the choice of the second operating mode by the on-board computer, and the joint operation of which indicates that the operating mode is specified by the driver.

FIG. 2 shows a highly schematized partial section through a motor vehicle according to a second embodiment. There can be seen an engine 11, which is held via dampers 12 on a frame 13 of the vehicle body, and a dividing wall 14, which extends between the engine compartment 15 and the passenger compartment 16, in order inter alia to shield the passenger compartment 16 from rolling- and engine noises. According to a first variant, the dampers 12 can be altered in their rigidity by the on-board computer 17, just as the shock absorbers on wheel suspensions of the vehicle, according to a selected operating mode. By the rigidity of the dampers 12 being set higher in the second, sporty operating mode than in the comfort-oriented first operating mode, their damping effect is reduced in particular for high frequency portions in the noise spectrum of the engine 11. As the engine noise spreads via the frame 13 into the passenger compartment 16, the difference in the spectral composition of the engine noise, resulting from the altered damping, is able to be heard by the driver at all times, and in particular an abrupt alteration to the acoustic color of the engine noise on switching over between the operating modes is able to be clearly distinguished. A corresponding effect is achievable with a controllable damper 18 between the engine 11 and the dividing wall 14 or by means of a loudspeaker 19, which in one of the operating modes superimposes a synthetic noise on the noise of the engine 11, in order to alter its acoustic color.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
an adaptive chassis configured to switch between a first operating mode and a second operating mode, the adaptive chassis comprising an operating parameter a value in the first operating mode that is different in the second operating mode at the same speed and at the same acceleration of the motor vehicle;
a control unit configured to:
evaluate a driving style; and
activate the first operating mode or the second operating mode based at least in part on the driving style; and
a signal generator configured to deliver a signal indicating whether the first operating mode or the second operating mode is active.

2. The motor vehicle according to claim 1, wherein the control unit is configured to evaluate the driving style based at least in part on a monitoring of longitudinal acceleration.

3. The motor vehicle according to claim 1, wherein the control unit is configured to evaluate the driving style based at least in part on a monitoring of transversal acceleration.

4. The motor vehicle according to claim 1, wherein the control unit is configured to evaluate the driving style based at least in part on a monitoring of, speed of change of a yaw rate.

5. The motor vehicle according to claim 1, wherein the control unit is configured to evaluate the driving style based at least in part on a monitoring of, steering wheel angular speed.

6. The motor vehicle according to claim 1, wherein the operating parameter is an operating state of an all-wheel drive of the adaptive chassis.

7. The motor vehicle according to claim 1, wherein the operating parameter is a hardness of a shock absorber of the adaptive chassis.

8. The motor vehicle according to claim 1, wherein the operating parameter is a strength of the assisted steering by a servo-steering mechanism.

9. The motor vehicle according to claim 1, wherein the operating parameter is a steering ratio between steering wheel and road wheels of the adaptive chassis.

10. The motor vehicle according to claim 1, wherein the operating parameter is a shift characteristic of an automatic transmission.

11. The motor vehicle according to claim 1, wherein the operating parameter is a relationship between accelerator pedal position and engine output.

12. The motor vehicle according to claim 1, further comprising a user interface that is configured to receive a choice between a specifying of the first operating mode (I), a specifying of the second operating mode, and the specifying of the first operating mode or the second operating mode by the control unit.

13. The motor vehicle according to claim 1, wherein the signal generator is configured to deliver an acoustic signal.

14. The motor vehicle according to claim 12, wherein the signal generator is configured to deliver a light signal, a color of the light signal indicative of the first operating mode or the second operating mode.

15. The motor vehicle according to claim 14, wherein the color of the light signal is further indicative of whether the first operating mode or the second operating mode is selected at the user interface.

16. The motor vehicle according to claim 14, wherein the light signal illuminates a display instrument configured to indicate a third operating parameter of the motor vehicle that is different from the first operating mode or the second operating mode.

17. The motor vehicle according to claim 1, wherein the signal generator is configured to generate the signal with a substantially continuous information content that changes on a change of the first operating mode or the second operating mode.
